(19) United States
(12) Patent Application Publication
(10) Pub. No.: US 2011/0010522 A1
(43) Pub. Date: Jan. 13, 2011

(54) MULTIPROCESSOR COMMUNICATION PROTOCOL BRIDGE BETWEEN SCALAR AND VECTOR COMPUTE NODES

(75) Inventors: Dennis C. Abts, Eleva, WI (US); Peter M. Klausler, Madison, WI (US); James Nowicki, Athens, WI (US)

Correspondence Address: SCHWEGMAN, LUNDBERG & WOESSNER, P.A., P.O. BOX 2938, MINNEAPOLIS, MN, 55402, US

(73) Assignee: Cray Inc., Seattle, WA (US)

(21) Appl. No.: 12/814,118

(22) Filed: Jun. 11, 2010

Related U.S. Application Data
(60) Provisional application No. 61/268,481, filed on Jun. 12, 2009.

(51) Int. Cl. G06F 13/36; G06F 15/76; G06F 9/02

(52) U.S. Cl. 712/3; 710/306; 712/E09.002

(57) ABSTRACT

A multiprocessor computer system includes a plurality of processor nodes coupled by a direct processor interconnect network, and a plurality of processor nodes coupled by an indirect processor interconnect network. A bridge directly couples the direct processor interconnect network and the indirect processor interconnect network.

### CLAIM OF PRIORITY

This application claims priority to United States Provisional Patent Application “Multiprocessor Communication Protocol Bridge Between Scalar And Vector Compute Nodes,” Ser. No. 61/268,481, filed Jun. 12, 2009.

### FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. MDA904-02-3-0052, awarded by the Maryland Procurement Office.

### FIELD OF THE INVENTION

The invention relates generally to communications hardware and software, and more specifically to a system and method for providing a network bridge between scalar and vector compute nodes.

### BRIEF DESCRIPTION OF THE FIGURES

FIG. 1 shows a functional block diagram of a system including a bridge interface between vector and scalar compute nodes according to embodiments of the invention;

FIG. 2 is a block diagram illustrating a destination address encoding used in embodiments of the invention;

FIG. 3 is a functional block diagram illustrating further details of a bridge interface and packet flow between vector and scalar nodes according to embodiments of the invention; and

FIG. 4 illustrates a ring buffer data structure according to embodiments of the invention.

### DETAILED DESCRIPTION

A multiprocessor system consists of a set of compute nodes that interoperate through a communication protocol. The medium over which the nodes communicate is referred to as the interconnection network. The network plays a central role in the performance of the multiprocessor since it determines the point-to-point and global bandwidth of the system as well as the latency of remote communication. The topology of the network refers to how the compute nodes communicate, and is described in terms of its routing, flow control, virtual channel resources, and packaging. Network topologies are broadly classified as direct (e.g. torus, hypercube, etc) and indirect (Clos, folded-Clos, butterfly, etc). A direct network has a processing node attached to each routing switch, whereas an indirect network has intermediate routing switches in addition to those connected to processing nodes. In indirect networks, the processing nodes are therefore only connected to a subset of the switches in the network, often at the perimeter of the network.

Described herein is a novel communication protocol and hardware to allow communication between a direct (3-D torus) and indirect (high-radix folded-Clos) network. A protocol bridge provides a conduit for packets of one network to be injected into the other. The underlying protocol provides support to enable heterogeneous computing between “vector” processing nodes (where a single instruction operates on multiple data elements) with “scalar” processing nodes (where a single instruction operates on a single data element). Most conventional microprocessors are an example of a scalar processor. The protocol bridge hardware and communication protocol acting as the conduit allows the processing nodes from each network to interoperate.

The systems and methods disclosed herein provide a high-bandwidth gateway between two dissimilar network topologies and node types (scalar and vector). A hardware implementation includes components that perform operations including:
Converts from a 68-bit flow control unit (flit) used by a 3-D torus (direct) network into a 24-bit physical unit (phit) used by a high-radix folded-Clos (indirect) network.
Converts data packets from a processing node with a 64-byte cache line granularity to a processing node with 32-byte cache line size.
Allows out-of-order packet delivery of responses in the folded-Clos network.
Ring buffer management with message completion notification.
Provides a scalable flow control mechanism using result-returning atomic memory operations (AMOs) to act upon the block transfer engine (BTE), where the AMO reply indicates success or failure of the BTE work request. This provides the necessary flow control between the software and hardware layers of the communication protocol.
Provides message-oriented and datagram communication across dissimilar processing nodes (scalar microprocessor and custom vector processor).

The inventive subject matter includes a protocol bridge that provides the conversion between compute nodes having a torus topology to compute nodes having a fat-tree topology. Such a bridge allows a user to log on to a compute node on one network and execute applications on nodes on either network. Input and Output packets are directed to a StarGate. FPGA chip. In some embodiments, the StarGate chip provides the necessary protocol conversion between the a shared-memory messaging used on some compute nodes and protocols such as SeaStar Portals or Sandia Accelerated IP messaging protocols used on other compute nodes. The chip acts as the gateway node between the BlackWidow high-radix folded-Clos (fat-tree) network and the XT3 3-D torus network.

In some embodiments, on both networks, the smallest unit of data transfer is a network packet. YARC network packets used in some embodiments consist of a number of 24-bit phits (physical transmission units). SeaStar network packets used in some embodiments consist of a number of 68-bit flits (flow control units). The StarGate chip provides the conversion between the two network packet formats.

Although the two network topologies differ, the various compute nodes may share a common network endpoint address space in some embodiments. For example, each network endpoint may have a unique 15-bit identifier. Bit 11 of this 15-bit identifier determines which type of network the endpoint is on, for example, the SeaStar or YARC network in some embodiments. Thus the endpoint network address space is allocated in 2048 blocks in some embodiments. (Identifier numbers 0-2047 are SeaStar network, 2048-4095 are YARC network, 4096-6143 are SeaStar network, and so on.) In some embodiments, the maximum sized system is 16K YARC endpoints and 16K SeaStar endpoints.

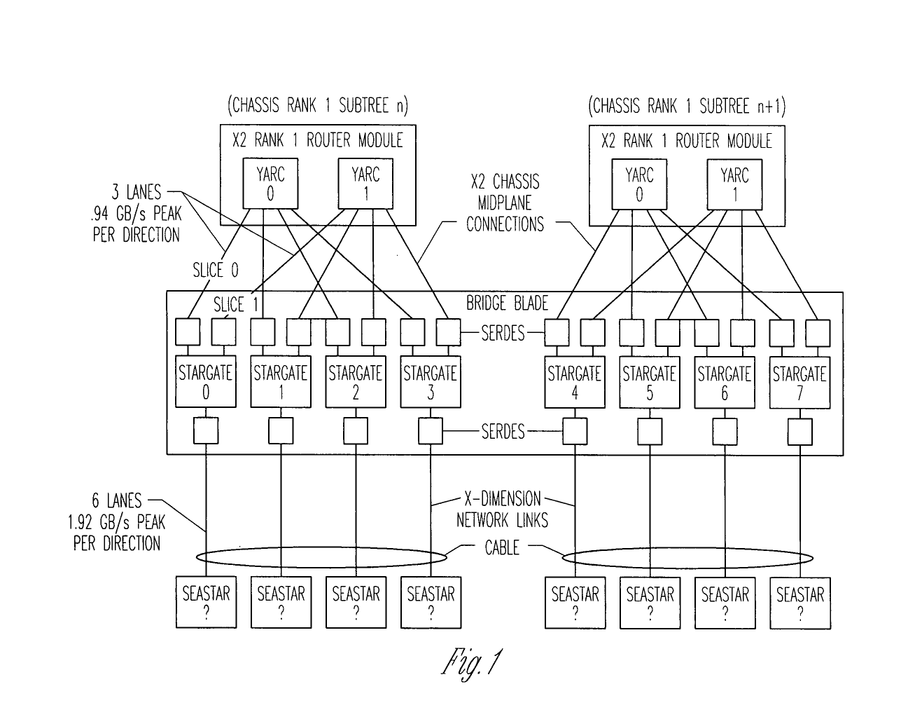

FIG. 1 shows a functional block diagram of a system including a bridge interface between vector and scalar compute nodes according to embodiments of the invention. In some embodiments, eight StarGate chips 110, along with SerDes (serializer/deserializer) interface chips 120 (PMC-Sierra PM8358 in some embodiments), are packaged on a bridge blade 102. In some embodiments, a system can contain 1-6 bridge blades 102 to provide 8-48 independent paths between the compute nodes 104 and 112 on either side of the bridge blade 102. The SerDes chips 120 provide the physical layer (point-to-point) connections between the StarGates 110 and YARC routers 106 and SeaStar routers 114. The StarGate chip 110 provides the link layer and is responsible for error-free packet delivery. In some embodiments it inserts a Cyclical Redundancy Check (CRC) into the parallel data, sends the data to the physical layer, re-establishes bit and byte alignment in the received parallel data, and uses the CRC to detect errors in the data transmission. The YARC 106 and SeaStar 114 chips provide the network layer for their respective networks, they direct network packets from a source to a destination across a sequence of point-to-point links.

In some embodiments a bridge blade 102 physically resides in a compute cabinet, for example, a Cray X2 compute cabinet available from Cray Inc., where it plugs into a blade slot in a chassis. For example in embodiments utilizing the Cray X2 chassis, the midplane connects the StarGates 110 to two R1 router modules 104 in the chassis. The YARC chips 106 on the R1 modules 104 provide connectivity to the rest of the X2 network.

On the X2 side, each StarGate 110 functions as an endpoint for the YARC fat-tree network. Four StarGates (equivalent to the four processors of a node) connect to each rank 1 subtree in the chassis via one even/odd slice pair per StarGate. Each StarGate is a valid YARC endpoint and has an MMR programmable YARC destination ID. Requests and responses from the X2 side are targeted at the StarGate's 110 destination ID. The StarGate 110 forwards the requests/responses to a SeaStar 114. In some embodiments, a YARC 106-to-StarGate 110 network link uses 8b/10b SerDes encoding.

A bridge blade 102 may utilize two network cables 122 to connect to the SeaStar 114 network. Each cable 122 can carry four StarGate-to-SeaStar links and plugs into an X-dimension network connector on a compute node chassis in some embodiments. Depending on the system configuration, the network cables 122 from a single bridge blade 102 may plug into the chassis backplane of multiple compute nodes and connects the four links to four SeaStars 114 on two XT blades 112. The SeaStars 114 on these blades provide connectivity to the rest of the XT network.

On the XT side, the StarGate 110 acts as a window from the Seastar network into the X2 network. Packets that arrive at the StarGate 110 from the Seastar 114 network are targeted toward a destination compute node such as a Black Widow processor. In some embodiments, the StarGate 110 data structures that track the in-flight messages are all organized according to an X2 node, which describes the shared address space of four BW processors. The StarGate 110 can communicate with 2048 X2 nodes in some embodiments. In some embodiments, a StarGate 110 keeps track of in-flight messages using Portals message tables. The Portals message tables keep track of messages from Seastars 114.

In some embodiments, changes are made to the network topology when an X2 compute node is attached. XT systems without an attached X2 are configured as a full 3D network torus. When a bridge blade is plugged into an XT X-dimension network connector, the four associated X-dimension tori are broken. As a result, the four X-dimension tori associated with the X-dimension connector become a mesh.

In some embodiments, an input port of the SeaStar 114 router has a 4K entry lookup table to allow up to 4096 endpoints in the network to be precisely routed. In some embodiments, of the 4K entries, half are allocated to the SeaStar network and half to the YARC network. Up to 32K endpoints are supported using eight global regions, where each region supports 4K endpoints.

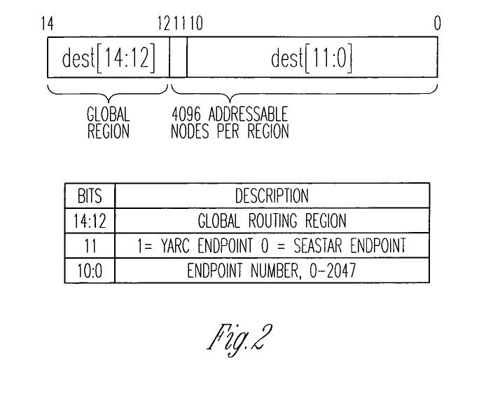

FIG. 2 is a block diagram illustrating a destination address encoding used in embodiments of the invention. The SeaStar network routing algorithm routes packets to BW destination endpoints through a specific StarGate 114 chip based on the BW endpoint number. Packets are first routed to a region 204. Once a packet is in the appropriate region, the packet is routed to one of the four SeaStars 114 associated with a bridge blade cable. In some embodiments, traffic crossing from the SeaStar network to he YARC network is load balanced by using the low-order two bits of the destination ID 202, i.e., dest[1:0], to select which SeaStar chip to use for routing. Depending on the number of bridge blades in the system and the number of global routing regions in the system, bridge blade connections can all be made to one region, or distributed across multiple regions.

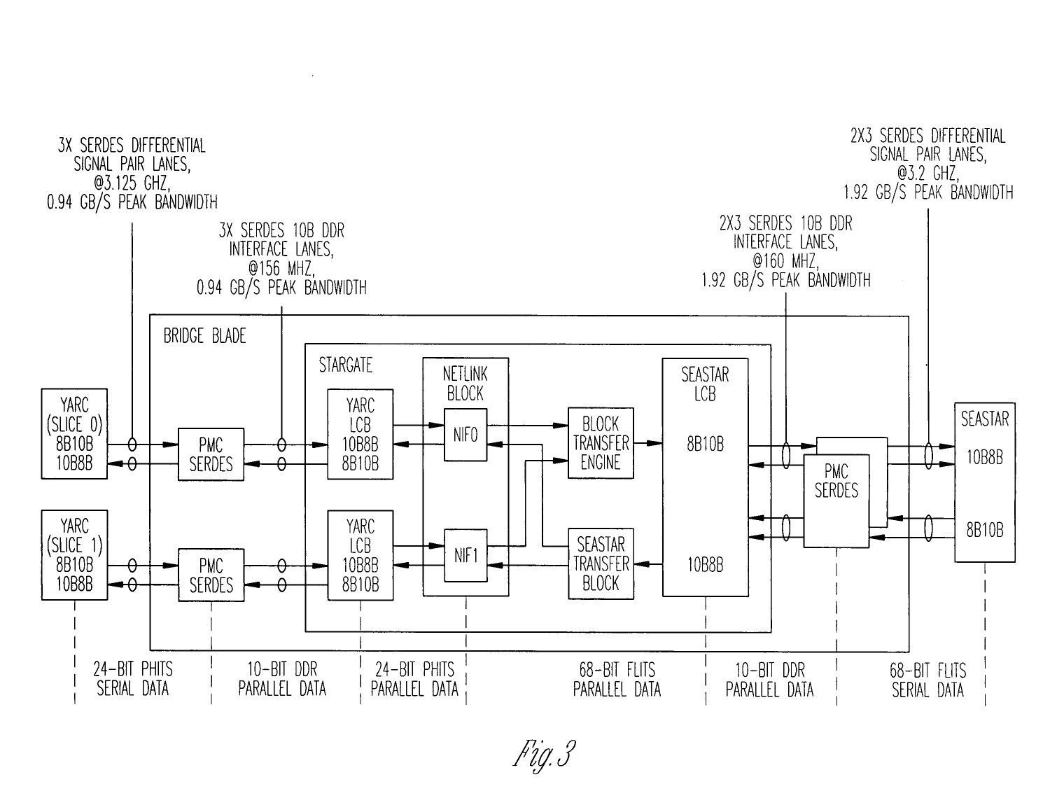

FIG. 3 is a functional block diagram illustrating further details of a bridge interface and packet flow between vector and scalar nodes according to embodiments of the invention. Transfers from YARC to SeaStar and from SeaStar to YARC will be described.

### YARC-to-SeaStar Network Transfers

In some embodiments, A BW (X2) processor initiates a YARC 106-to-SeaStar 114 transfer. The processor assembles the network packets to be transferred in its local memory. Next the processor builds a descriptor table that defines the physical addresses and length of the data being transferred. Then the processor issues a compare and swap atomic memory operation to the Block Transfer Engine (BTE) 306 on a target StarGate 110 (YARC network endpoint). The operands of the compare and swap instruction include a pointer to the descriptor table, the target SeaStar destination ID, and control bits. The BTE 306 verifies the request is valid and queues the request. Once the command has been successfully queued and is next in line for execution, the BTE 306 begins fetching the descriptors from BW memory. The BTE 306 receives the descriptor responses, fetches the appropriate data out of BW memory, and transmits the data to the SeaStar 114.

On the YARC network, the packets are targeted for a specific StarGate 110, based on the StarGate's destination ID. The packets are routed from the destination BW processor to a pair of YARC chips that physically connect to the target StarGate. (In some embodiments, one YARC handles even cache line addresses, a second YARC handles the odd cache line addresses.) The two YARCs generate a CRC on the outgoing packets, perform the 8b/10b encoding of the 24-bit parallel phits, serialize the data, and send the data to a pair of PMC SerDes chips located on the bridge blade 102. In some embodiments, the YARC-to-SerDes interface consists of three lanes in each direction, where each lane is a differential signal pair.

The SerDes chips 120 function as a physical layer. They deserialize the incoming data and send it to the YARC link control blocks (LCBs) 316. In some embodiments, the SerDes-to-YARC LCB 316 interface is 10 data bits, plus control Double Date Rate (DDR) for each SerDes lane.

A StarGate 110 has two YARC LCBs 316, one for each network slice. The YARC LCBs 316 implement the link layer of the YARC network; they facilitate the reliable transfer of data between the PMC SerDes chips 120 and the core logic in the StarGate 110. The LCBs check for CRC errors on incoming packets, and initiate retries on detected errors. The LCBs perform 10b/8b encoding, convert the 10-bit parallel data from the PMC SerDes to 24-bit parallel phits, and pass the 24-bit parallel phits to the Netlink block.

Two Network Interfaces (NIFs) 312 in the Netlink block 310 serve as the input and output ports to the YARC network, and contain routing information to identify available uplinks and faulted nodes in the BW network. A NIF 312 receives the 24-bit YARC phits and converts them into 68-bit SeaStar flits.

A Netlink block 310 also contains a Local block (not shown in the figure). The Local block supports memory-mapped register (MMR) access to StarGate 110 from the BW processor and the hardware supervisory system (HSS). The Local block contains the necessary exception handling interface and error status flags.

68-bit SeaStar flits pass thru the BTE and enter the SeaStar LCB 304. The SeaStar LCB implements the link layer of the SeaStar network; it facilitates the reliable transfer of data between the core logic in the StarGate 110 and the PMC SerDes 120 chips that connect to the SeaStar 114. The SeaStar LCB 304 generates a CRC on outgoing packets, performs 8b/10b encoding, and converts 68-bit parallel flits to 10-bit parallel data. The interface to the PMC SerDes chips 120 consists of six 10-bit data plus control DDR per SerDes lanes.

The PMC SerDes chips 120 function as the physical layer between the StarGate 110 and SeaStar chips 114. The SerDes units 120 receive 10-bit parallel data from the SeaStar LCB 304, serialize the data, and sends it to the SeaStar 114. The SeaStar 114 deserializes the data, checks for CRC errors, and performs retries on errors. The SeaStar 114 then routes the packet to the proper SeaStar network destination.

### SeaStar-to-YARC Network Transfers

SeaStar 114-to-YARC 106 transfers consist of Portals or Sandia Accelerated IP messages in some embodiments. Messages can be of arbitrary length, and are composed of a message header packet, some number of message data packets, and a full message CRC. Each packet has a header flit and up to 8 data flits. The header flit contains the SeaStar source ID, the BW destination ID, start-of-message and end-of-message control bits, and other control information. Flits are 68-bits wide (64 bits of data and 4 bits of sideband information).

A processor initiates a Seastar-to-YARC transfer. In some embodiments, the processor is an Opteron processor. The processor assembles the message in local memory. The destination ID for all message packets is equal to a targeted BW processor. The message packets are sent out to the network where they are first routed to the appropriate region, to a SeaStar within that region that has a bridge blade connection, then to the StarGate connected to the SeaStar. The StarGate then transfers the packet to the target BW processor's local memory.

In some embodiments, a SeaStar Transfer Block (STB) 308 in the StarGate 110 handles operations associated with a SeaStar-to-YARC message transfer. A BW node uses a ring buffer in its local memory to store incoming messages. The STB keeps track of the ring buffers for up to 2048 BW nodes. When the StarGate receives the message header packet, it determines the length of the message and whether the message has room in the target BW ring buffer. If so, the STB 308 processes the packet, generates a running CRC, and sends the packet to the BW node. The STB 308 continues to process data packets until it receives and end-of-packet flag. The STB then sends full message CRC and error status. The STB 308 keeps track of messages that are in process, checking for errors as message packets are transferred.

The SeaStar-to-YARC packet flow is similar to the YARC-to-SeaStar packet flow, but in reverse order. The operations described below illustrate how the packets flow between the SeaStar and YARC networks under control of the STB 308.

The SeaStar performs the 8b/10b encoding of the 68-bit parallel flits, generates a CRC on the outgoing packets, serializes the data, and sends the data to a pair of PMC SerDes chips 120 located on the bridge blade 102. The SeaStar-to-SerDes interface consists of six lanes in each direction, where each lane is a differential signal pair.

The PMC SerDes chips deserialize the incoming data and send it to the SeaStar LCB in the StarGate 110. The SerDes-to-SeaStar LCB 304 interface is 10 data bits, plus control DDR for each SerDes lane.

The SeaStar LCB 304 performs 10b/8b encoding, converts the 10-bit parallel data from the PMC SerDes to 68-bit parallel flits, and pass the 68-bit parallel flits to the Netlink block. The SeaStar LCB 304 also checks for CRC errors on incoming packets, and initiate retries on detected errors.

The Netlink block 310 converts the 68-bit flits to 24-bit phits. The 24-bit parallel phits from NIFs 312 (even/odd slice) are sent to YARC LCBs 316.

The YARC LCBs 316 perform the 8b/10b encoding of the 24-bit parallel phits, convert the 24-bit phits to a 10-bit interface, generate a CRC on the outgoing packets, and send the data to a pair of PMC SerDes chips 120. The YARC LCB-to-SerDes interface is 10 data bits, plus control DDR for each SerDes lane.

The PMC SerDes 120 serializes the 10-bit parallel data from the YARC LCBs, and sends the data to the YARC chips 106. The SerDes-to-YARC interface is consists of three lanes in each direction, where each lane is a differential signal pair.

The YARC chips deserialize the data, check for CRC errors, and perform retries on errors. The YARCs 106 then route the packets to the destination BW node memory.

### Scalable Flow Control Using Atomic Memory Operations

The BTE work queue is a hardware-managed queue structure that is shared by all vector processors. When software needs to insert an entry on the BTE work queue, it must be flow controlled to avoid overflowing the queue. For a point-to-point connection, this flow control occurs with the implicit back pressure in the network. However, when the data structure is shared across many processing nodes, each node is unaware of the amount of free space in the shared structure. Therefore, a flow control method is used whereby the hardware communicates a status word in the reply with a positive acknowledgement (Ack) for success, or negative acknowledgement (Nack) on failure.

The atomicity of the BTE request is desirable for the flow control mechanism to work. Therefore, a result-returning atomic memory operation (AMO) is used to initiate the request in some embodiments. The relevant fields of the request are encoded in the operand fields of the AMO. Software initiates a block transfer by sending an atomic compare-and-swap with the request encoded in the operand fields (compare-value and swap-value). If the BTE work queue has space available for the new request it is appended to the work queue, and an Ack reply is sent to the requestor. Otherwise, if the BTE work request is full, the request is dropped and a Nack reply is sent to the requestor. Upon receipt of a Nack, the software layer will retry the request after some elapsed time (back-off period).

### Network Packet Conversion

The StarGate hardware cooperates with device driver software operating on the BlackWidow multiprocessor system in order to manage the ring buffers in BlackWidow memory.

A set of mechanisms and processes are used to enable:
Message completion notification with guaranteed data integrity
Out of order consumption of messages
Maintains cacheline alignment of data for maximum network bandwidth efficiency

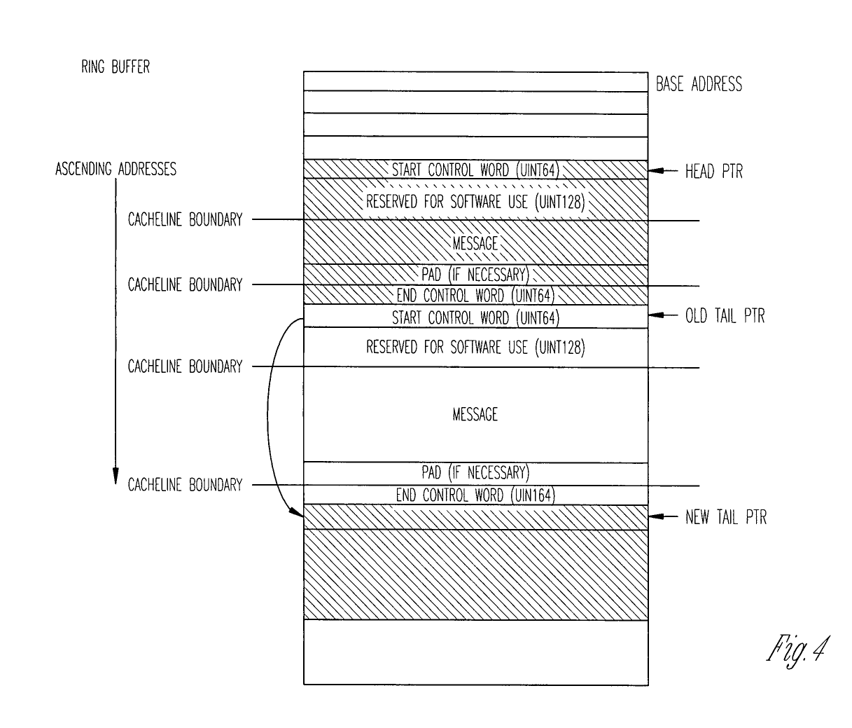

A message sent to the Blackwidow is comprised of one or more packets. The StarGate manages ring buffer pointers for multiple BlackWidow destination nodes. A ring buffer is an area in the memory of a BlackWidow node that receives messages from the 3-D torus network. FIG. 4 illustrates a ring buffer data structure according to embodiments of the invention.

When the StarGate receives the start of a message from the 3-D torus network, it looks up the head and tail pointers as well as the length for the BlackWidow side destination and checks whether the message will fit into the ring buffer. If the message will fit, the StarGate will adjust the tail pointer based on the length of the message that is starting. The StarGate will leave some pad at the end of the message when setting the tail pointer for cache line alignment purposes. When the BlackWidow software consumes messages out of the buffer it will move the head pointer. At any point in time, there may be many messages in progress into the same ring buffer. They can complete out of order, and the BlackWidow software will move the head pointer and reclaim the buffer space when the message at the head of the ring completes.

Messages can arrive out-of-order, therefore a start of message and an end of message control word encapsulate each message in the BlackWidow ring buffer. This allows the device driver software to detect the arrival and completion of the message, Each will control word is a 64-bit word at the beginning and end of the message. The start of message control word contains a pointer to the next start of message control word in the ring buffer. The end of message control word contains an error code and a valid bit. A message in the ring buffer includes a start of message control word, the message body including higher-level protocol headers, and an end of message control word. The control words that encapsulate the message allow for dynamic allocation and efficient message traversal.

The alignment of the control words and the message data is designed to maintain cache-line alignment of the payload data to maximize network efficiency. Given a 256-bit cache line comprised of four 64-bit words, the end of message control word is the first 64 bits of a cache line. The start of message control word for the next message is the next 64 bits of the cache line. This allows the start of message control word to already be in the cache when the BlackWidow software has just read the end of message control word for the previous message. After the start of message control word, two 64-bit words are reserved for software use. This allows the header and body of the message to start out cache line aligned and will in many cases minimize the number of write packets that must be generated.

When the last packet of a message is received and processed by the StarGate, the information about message completion is moved to the completion pending list. This entry is maintained until acknowledgements have been received for all data packets that have been written to the ring buffer. When all acknowledgements have been received, the end of message control word is written with the valid bit set. This informs the device driver on the BlackWidow (vector) node that it can consume the valid message.

Out-of-Order Packet Delivery and Conversion Between 32 and 64-byte Cache Line Sizes

The BlackWidow (vector) system is a distributed shared memory system with a 32-byte cache line size. The XT3 (scalar) system is a distributed memory system with a 64-byte cache line. The StarGate protocol bridge acts as an intermediary between these two node types and provides the following features in some embodiments:
The individual packets of a message from a BlackWidow (vector) node destined to the XT3 (scalar) node must appear to arrive in order.
BlackWidow (vector) memory operations will read a 32-byte cache-line, and two 32-byte response packets are coalesced to form a 64-byte packet destined for the XT3 (scalar) node. The BlackWidow response buffer on StarGate will wait for the pair of 32-byte responses before creating the XT3 network packet.

The StarGate hardware maintains a pair of buffers—corresponding to each half of a 64-byte cache line request. Each buffer has a full bit indicating that the response for that 32-byte chunk has arrived. When both 32-byte responses have arrived, (i.e. both full bits are set), a new packet is synthesized destined for the target XT (scalar) IO node. The 64-byte payload is formatted as eight 68-bit flits. Bits [63:0] represent the data payload, bits [66:64] are the virtual channel over which the packet will travel, and bit [67] is a tail bit to indicate the end-of-packet.

Embodiments of the subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments and other embodiments not specifically described herein will be apparent to those of skill in the art upon reviewing the above description.

What is claimed is:

1. A multiprocessor computer system, comprising:
a plurality of processor nodes coupled by a direct processor interconnect network;
a plurality of processor nodes coupled by an indirect processor interconnect network; and
a bridge directly coupling the direct processor interconnect network and the indirect processor interconnect network.

2. The multiprocessor computer system of claim 1, wherein the bridge is further operable to convert between direct flow control units (flits) of the direct processor interconnect network and physical units (phits) of the indirect processor interconnect network.

3. The multiprocessor computer system of claim 1, wherein the direct processor interconnect network comprises a three-dimensional torus network, and the indirect processor interconnect network comprises a Clos network.

4. The multiprocessor computer system of claim 1, wherein a first of the indirect and direct processor interconnect networks comprises vector processors and the other of the direct and indirect processor interconnect networks comprises scalar processors.

5. The multiprocessor computer system of claim 4, wherein the system is further operable to buffer and reorder packets sent from a vector processor node to a scalar processor node such that the packets appear to arrive at the scalar processor node in order.

6. The multiprocessor computer system of claim 1, the bridge further operable to convert between different cache line sizes between the direct and indirect processor interconnect networks.

7. The multiprocessor computer system of claim 1, the bridge further operable to manage a ring buffer in an indirect network node receiving a message from a direct network node.

8. The multiprocessor computer system of claim 1, the bridge further operable to provide a flow control mechanism using result-returning atomic memory operations (AMOs) to act upon a block transfer engine (BTE), where the AMO reply indicates success or failure of the BTE work request.

9. A method of operating a multiprocessor computer system, comprising:
operating a plurality of processor nodes coupled by a direct processor interconnect network;
operating a plurality of processor nodes coupled by an indirect processor interconnect network; and
coupling the direct processor interconnect network and the indirect processor interconnect network via a bridge.

10. The method of operating a multiprocessor computer system of claim 9, further comprising converting between direct flow control units (flits) of the direct processor interconnect network and physical units (phits) of the indirect processor interconnect network.

11. The method of operating a multiprocessor computer system of claim 9, wherein the direct processor interconnect network comprises a three-dimensional torus network, and the indirect processor interconnect network comprises a Clos network.

12. The method of operating a multiprocessor computer system of claim 9, wherein a first of the indirect and direct processor interconnect networks comprises vector processors and the other of the direct and indirect processor interconnect networks comprises scalar processors.

13. The method of operating a multiprocessor computer system of claim 12, further comprising buffering and reordering packets sent from a vector processor node to a scalar processor node such that the packets appear to arrive at the scalar processor node in order.

14. The method of operating a multiprocessor computer system of claim 9, further comprising converting between different cache line sizes between the direct and indirect processor interconnect networks.

15. The method of operating a multiprocessor computer system of claim 9, further comprising managing a ring buffer in an indirect network node receiving a message from a direct network node.

16. The method of operating a multiprocessor computer system of claim 9, further comprising providing a flow control mechanism using result-returning atomic memory operations (AMOs) to act upon a block transfer engine (BTE), where the AMO reply indicates success or failure of the BTE work request.
